(19) United States
(12) Patent Application Publication
(10) Pub. No.: US 2007/0252035 A1
(43) Pub. Date: Nov. 1, 2007

(54) Unmanned vehicle

(76) Inventor: James E. Hubbard JR., Hampton, VA (US)

Correspondence Address: Robert C. F. Perez;c/o Kaufman & Canoles, P.O. Box 3037, Norfolk, VA, 23514-3037, US

(21) Appl. No.: 11/604,995

(22) Filed: Nov. 28, 2006

Related U.S. Application Data
(60) Provisional application No. 60/740,438, filed on Nov. 29, 2005.

(51) Int. Cl. B64C 13/00

(52) U.S. Cl. 244/75.1

(57) ABSTRACT

A UAV or watercraft includes a navigation system that is configured to identify and make use of convective energy in a fluid medium through which it travels. The energy is used to provide movement through the medium and extend vehicle endurance or range without the need for additional fuel. In particular, the vehicle includes one or more sensors that are adapted to detecting such energy sources, and a controller that allows the vehicle to autonomously exploit them for energy gain while conducting a useful mission. In particular implementations, the vehicle may also include sensors and a feedback loop for adjusting lift profile of airfoils or hydrofoils to improve lift efficiency.

### CROSS-REFERENCE TO RELATED APPLICATION

This application claims the benefit of U.S. Provisional Application No. 60/740,438, filed Nov. 29, 2005 for “A Low Altitude, Long Enduring Vehicle,” which is incorporated by reference herein in its entirety.

### STATEMENT REGARDING FEDERALLY SPONSORED RESEARCH OR DEVELOPMENT

The U. S. Government has a paid-up license in this invention and the right in limited circumstances to require the patent owner to license others on reasonable terms as provided for by the terms of Cooperative Agreement No. NCC-1-02043 awarded by the National Aeronautics and Space Administration.

### FIELD OF THE INVENTION

This invention relates generally to unmanned vehicles and more particularly to unmanned vehicles having automated navigation systems.

### BACKGROUND

Unmanned aerial vehicles (UAVs) can be used for a variety of applications. In particular, it may be undesirable to use manned flight vehicles for reasons of operator safety or the like. Thus, UAV missions may include surveillance, reconnaissance, target acquisition and/or designation, data acquisition, communications datalinking or relaying, decoy, jamming, harassment, or the like with both day and night operational capabilities. Conventional UAVs are typically manually controlled by an operator who receives information regarding the UAV's position, attitude and environment by way of a variety of sensors and cameras installed on the UAV.

As these missions become more complex and requirements for payload capacity, range, and endurance increase, UAVs have tended to become larger and more expensive. The design of UAVs is typically driven by mission requirements which, in turn, dictate payload capacity. The vehicle weight, size, and fuel capacity are then determined as part of a design optimization process which generally has sought to balance these parameters against the range and endurance needs of the mission. Thus, a UAV having increased endurance without requiring a corresponding increase in fuel, and thereby impacting capacity for mission-related payloads such as sensor suites or ordnance, would be useful in a number of applications.

### SUMMARY

In accordance with one embodiment of the present invention, a control system for an unmanned aerial vehicle includes a sensor, constructed and arranged to identify atmospheric energy, and a controller, configured to receive information from the sensor and to produce control signals to flight control elements of the unmanned aerial vehicle so that the identified atmospheric energy can be used by the unmanned aerial vehicle in a flight operation.

In accordance with another embodiment of the present invention, the control system may further include a lift sensor and a drag sensor and the controller may be further configured to receive information from the lift and drag sensors and to use the received information to produce control signals to control aerodynamic surfaces of the unmanned aerial vehicle such that a drag induced by a wing of the unmanned aerial vehicle is reduced.

In accordance with another embodiment of the present invention, a method for controlling an unmanned aerial vehicle includes measuring a lift force on a wing of the unmanned aerial vehicle, measuring a drag force on the wing, and using the measured lift and drag to control aerodynamic surfaces of the wing such that a drag induced by the wing is reduced. The method may also include controlling the surfaces to approximate an elliptic wing span loading.

In accordance with yet another embodiment of the present invention, a method for controlling an unmanned aerial vehicle includes detecting atmospheric energy, and controlling the vehicle such that a portion of the detected energy is used to provide lift to the vehicle. The method may also include controlling aerodynamic surfaces of a wing of the vehicle such that a drag induced by the wing is reduced, and/or to approximate an elliptic wing span loading.

### BRIEF DESCRIPTION OF THE DRAWINGS

FIG. 1 is an illustration of a UAV navigating in accordance with an embodiment of the present invention;

FIG. 2 is a block diagram of a control system in accordance with an embodiment of the present invention; and

FIG. 3 is an illustration of a control architecture for a wing of a UAV in accordance with an embodiment of the present invention.

### DETAILED DESCRIPTION

One aspect of an embodiment of the present invention includes a navigation system for UAVs that uses convective energy in the atmosphere (thermals) to gain altitude and extend vehicle endurance or range without the need for additional fuel. In particular, the UAV includes one or more sensors that are adapted to detecting such atmospheric energy sources, and a controller that allows the vehicle to autonomously exploit them for altitude gain while conducting a useful mission.

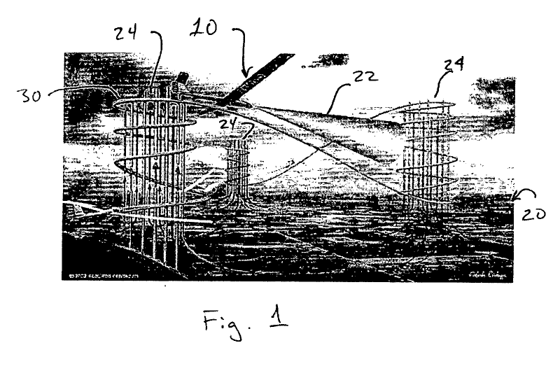

As illustrated in FIG. 1, a vehicle 10 navigates over a landscape 20 while performing its mission. The vehicle includes sensors that are used to interrogate atmospheric conditions at range. In one example, the vehicle system and sensor package includes light detection and ranging (LIDAR), a technique that uses laser light 22 to interrogate a target. Atmospheric features such as suspended aerosols tend to scatter and reflect the laser light. The backscatter, which is a small portion of this light, may be used to infer characteristics of the target, including, for example, velocity gradients. By pulsing the LIDAR signal, range to the target may be determined.

As illustrated in FIG. 1, there may be a number of regions of the atmosphere 24 that include upward convective currents, known as thermals, that may be located using the LIDAR signal. In addition to LIDAR sensing, other active and electro-optical sensors may be installed in the aircraft to assist in the detection and ranging of thermals. While a single thermal may provide some additional energy to the vehicle in a basic soaring maneuver, it is also possible to exploit a series of thermals which are known to be frequently found to be in lines or “streets.” By traveling a path 30 that includes extended time within the regions including the thermals 24, the vehicle 10 may take advantage of the atmospheric energy contained in the thermals to provide lift to the vehicle.

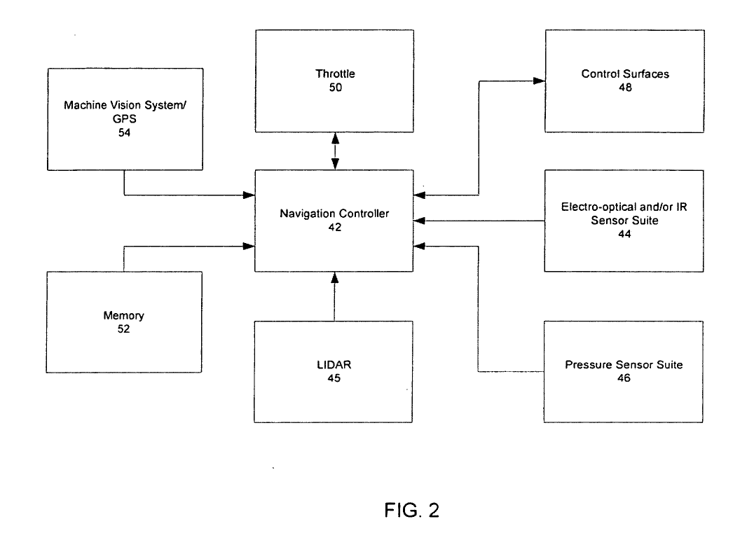

In a particular example, the vehicle 10 identifies a thermal at a distance from the vehicle. The vehicle's navigation system then alters its course so that the vehicle will enter the thermal. Once the vehicle enters the thermal, the vehicle autonomously spirals within the thermal, gaining altitude in a soaring maneuver. The vehicle's sensor suite continues to provide feedback to the navigation system on the location of the thermal's edges, as shown in the block diagram in FIG. 2, described in more detail below. For example, the sensors may detect temperature gradients, indicating a border region between the warmer air of the thermal and the cooler air of the ambient atmosphere. By flying in circles while keeping the right wing tip at one side of the gradient and the left wing tip at the other, the vehicle will tend to maintain its position within the upward air column and spiral upward.

As shown in FIG. 1, a particular useful approach is to enter a thermal, spiral upward, using the lift of the convective current to gain altitude, then to glide, or engage in powered flight, or a combination thereof, to another detected thermal. By moving from thermal to thermal in this manner along a detected thermal street, highly extended flight times are possible. Where the vehicle's mission requires that it be above a particular region of the landscape, the thermal detection and exploitation system may include restrictions to ensure that it does not stray from its station while pursuing thermals. That is, thermals that are located outside of a defined on-station region, or within a determined distance of a flight path between a pair of waypoints may be excluded from use.

During the upward spiral, as an additional fuel-saving measure, the vehicle may be operated with a reduced throttle or with the motor shut off entirely, depending in part on whether the particular thermal is strong enough to support the vehicle without assistance. That is, when atmospheric conditions allow, the UAV may become a glider, and make use of the atmospheric energy to gain altitude while conserving its fuel load. In particular, when the upward velocity of an air mass exceeds the still air descent rate of the vehicle, there may be a net altitude gain without any expenditure of energy on the part of the vehicle.

In certain embodiments, a sensor-actuator system may be distributed over a wing of the UAV to sense and then adjust the forces and moments acting on the vehicle to optimize lift and drag in order to use the available energy more efficiently and thereby extend the vehicle's endurance. In theory this can allow for endurance gains of three to four times the available on-board energy extending a two-to-three hour mission to as much as 12 hours without the requirement for additional fuel.

In a particular embodiment, an electro-optical and/or IR sensor suite may be used to perform a broad area search for atmospheric energy. Once an energy source is detected, an on-board LIDAR system will employ conical scanning to determine wind vectors in the environment via line of sight Doppler shift measurements, for example. Once a thermal has been detected and the position determined, the vehicle may proceed to that energy source to gain altitude and center itself to gain maximum altitude prior to moving onto the next energy waypoint, using minimal fuel in the process. During these maneuvers the navigation system may not only direct the UAV to the energy source, but keep the UAV heading in the general direction required by the mission. Using these techniques, energy waypoints may be used for extending range.

FIG. 2 is a block diagram of a control system 40 for a vehicle in accordance with an embodiment of the present invention. As described above, the navigation controller 42 accepts inputs from a variety of sensor suites. These suites include, for example, the electro-optical/IR sensor suite 44 that may be used to perform the wide area scans, the LIDAR 45 that may be used to identify and quantify fluid flow direction and magnitude and a pressure sensor suite 46 that may be mounted on or near control surfaces 48 of the vehicle as further described below. Furthermore, the navigation controller 42 will generally be in communication with the control surfaces 48 and a throttle or motor control 50. This communication may be strictly one way in order to provide instructions to those components for controlling the direction, attitude and speed of the vehicle, or may be (as shown in the FIG.) bidirectional so that the controller 42 may receive information regarding the actual positions of the control surfaces and/or throttle setting.

Additionally, the control system 40 may include a memory 52 that may be pre-programmed with waypoints, terrain features and other navigational information. Likewise, a machine vision system 54, GPS, and/or other observation system may be provided in order to determine a location of the vehicle relative to the navigational information in the memory. Finally, though not illustrated, the control system 40 may include a communications facility for receiving changes to its pre-programmed instruction and/or for sending telemetric data to an off-board human or machine controller.

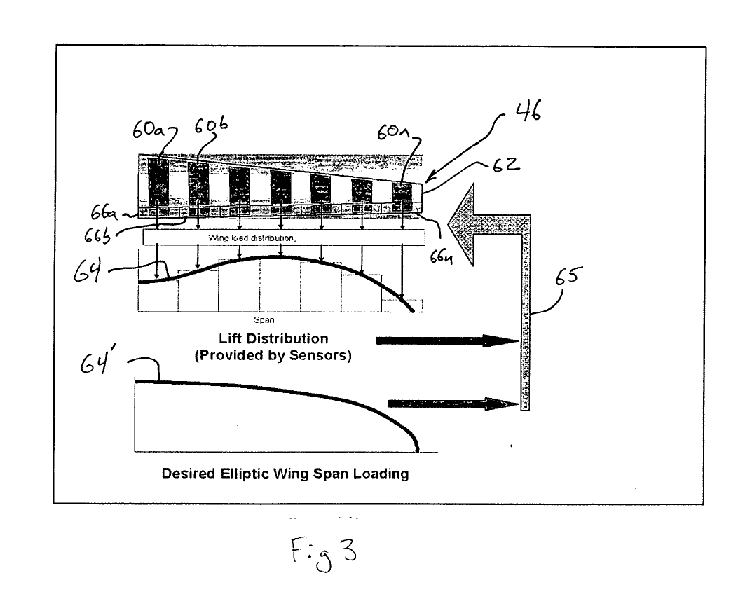

As mentioned above, and as illustrated in FIGS. 2 and 3, embodiments of the present invention may include a pressure sensor suite 46 for assistance in maintaining position within a thermal and otherwise controlling the vehicle. The pressure sensor suite 46 includes a number of pressure sensors 60a, 60b, . . . 60n, as further described below. In a particular embodiment, the pressure sensors may be conformal sensors made from a foil or film material and adhered to or built into the structure of a wing or tail section 62 of the aircraft.

The pressure sensors 60a, 60b, . . . 60n, measure pressure on the wing, from which parameters such as lift, drag, center of pressure and the like may be determined. These parameters may be used, for example, to calculate a lift distribution 64 along a span of the wing. This information may, in turn, be used by the navigation controller 42 (not shown in FIG. 3) via a control loop 65 in order to make adjustments to control surfaces 66a, 66b, . . . 66n, provided along an edge, for example, of the wing 62. In the illustrated example, the controller is programmed with a desired span loading, such as an elliptical span loading 64′, which is also used as in input to the control loop 65. Other loadings may be produced as desired by appropriate changes to relative positions of the control surfaces 66a-66n, and may be pre-programmed, or may be determined by the controller in accordance with needs of the vehicle (e.g., maneuvering requirements may be balanced against loading goals to provide appropriate positioning while maximizing endurance).

In an example of the operation of the system, the control loop illustrated in FIG. 3 may be used in order to provide real-time adjustments to airflow around the vehicle in order to provide efficient wing loading profiles. For example, once on-station in the mission airspace cone, the sensors 60a-60n may be used to “feel and react to” the flow and achieve on-station persistence by loitering within a thermal. In an urban environment, for example, there are numerous thermals around buildings, parking lots, rivers, and roadways that can be exploited. As the controller 40 positions the vehicle in a thermal using the LIDAR 45 and the EO/IR sensor suite 44, the pressure sensors 60a-60n measure airflows and the controller 40 adjusts the wing profile in response, thus allowing the vehicle to operate with minimum induced drag and efficient wing loading throughout the flight envelope.

In general, vehicle drag is comprised of induced drag and parasitic drag. At high speeds parasitic drag is dominant. At a maximum lift-to-drag ratio parasitic and induced drag are approximately equal. At low speeds such as those encountered during gliding maneuvers such as thermaling, may be the biggest factor in efficiency of performance. It can be shown that induced drag is not generally directly a function of aspect ratio. In contrast, it is wing span and span efficiency that are of primary importance rather than wing area. Span efficiency may be determined by the wing lift distribution.

Embodiments of the present invention may use a selected, relatively-large wing span with the goal of achieving an elliptical lift distribution. It can be shown that a maximum span efficiency is produced when an elliptical lift distribution is achieved, thereby improving efficiency and reducing induced drag. However, it should also be noted that achieving an elliptical lift distribution is not necessarily a result of using an elliptic planform for the aerodynamic surfaces. At low Reynolds number and small UAV scales an elliptical planform will not generally yield elliptic load distributions due to variations in Reynolds number along the wing. Instead, as described above, through measurement and feedback to control surfaces, the loading may be adjusted actively to ensure minimum induced drag during flight. This may allow efficient aerodynamic flight throughout the flight envelope and will provide an ability to exploit a wide range of varying thermal strengths and densities. Though described as a strategy for maximizing use of thermals as detected by the sensor suites, the measurement of loads and adjustments to wing effective profiles may be included as an efficiency-improving strategy throughout a flight path of the vehicle as desired.

As described above, sensors 60a-60n make use of shaped portions of electroactive sensitive films to obtain distributed pressure profiles. In part, these profiles are obtained by integrating the relevant parameters, such as film charge which is generally proportional to applied pressure, as a spatial integral over the surface where the film is attached, i.e., the sensing aperture. The sensor design may be configured to optimize the parameters and weighting functions may be used for the selectively shaped electrodes or spatial filter characteristics in order to condition a strain response of a sensing film layer to measure and characterize static and/or dynamic pressure parameters along the wing surface such as center of pressure. Examples of such sensors are described in U.S. Provisional Patent Application 60/740,437, filed Nov. 29, 2005 for “Conformal Sensors for the Measurement of Aerodynamic and Hydrodynamic Lift and Drag,” which is incorporated by reference herein. As will be appreciated, other lift and/or drag sensors may be used such as electrically scanned pressure sensors, or pressure sensors available from Mensor Corporation of San Marcos, Tex. or Scanivalve Corporation of Liberty Lake, Wash. Electroactive materials as mentioned above may include, for example, piezoelectric materials, piezoresistive materials and quantum tunneling composite materials.

In operation as described above, the control surfaces 66a-66n (for example, trailing-edge flap segments as illustrated in FIG. 3) and actuators may be blended into the wing structure to minimize or reduce air flow boundary layer perturbations of the upper lifting surface. In this regard, a minimum of forward steps and/or sharp corners should be allowed.

The sensors may be applied on surfaces of the wing utilizing adhesive, or may even be manufactured as part of the wing itself. In particular, for a composite wing, the sensors may be included as a component of the wing during formation of the composite part. Various sensor configurations are possible such as, for example, strips parallel to the chord length as shown in FIG. 3. In one variation, the film, such as a polyimide film, can also be applied as a single sheet over the entire wing or it can be spayed and cured.

In a particular implementation, thin-film sensors may be mounted to a wing, then calibrated using other, known-performance sensors. Output resistance of the sensor can then be utilized to measure static pressure relative to plate angle of attack (AOA) and changes in air flow velocity.

Additional endurance-increasing features may be incorporated into embodiments of the present invention. For example, solar cells and electrical storage batteries may be included in order to provide additional energy for operation of the vehicle. The vehicle itself may be made from light materials such as foams, carbon-fiber composites, aluminum or the like.

In certain embodiments, it may be useful for the vehicle to include the capability to deploy additional sensor assets. Such assets may include, for example, mini-and micro-UAVs which have the capability to fly down into urban canyons, thereby achieving otherwise impossible viewing angles through windows, down streets, alleyways and other narrow passageways.

During limited operations such as those associated with the urban environment, strategic objectives can be more readily and consistently achieved through the cumulative effect of persistent surveillance and strike. Aspects of embodiments of the present invention may allow a UAV to be an integrated airborne surveillance and communications system designed to provide continuous temporal coverage over a potentially very large area in an urban environment. Operation of such a UAV in theater may involve a stand-off deployment as a platform for a system of modular, autonomous network-centric sensors. By exploiting atmospheric energy as described above, a UAV may become a reliable and enduring platform that can autonomously deploy multiple sensor delivery vehicles (MAVs, small UAVs, UGVs, or UWVs), and remain on-station in a potentially hostile environment to control the sensor deployment, while continuously relaying the sensor data to the information customer. In this role, the UAV may relay observations from its deployed sensors and its on-board sensors and may be in communication with a command and control center such as a search and rescue headquarters, a battle management center or a disaster management center, for example. The UAV may further be in communication with communications satellites for relaying data to distant points.

The foregoing presentation of the described embodiments is provided to enable any person skilled in the art to make or use the present invention. Various modifications to these embodiments are possible, and the generic principles presented herein may be applied to other embodiments as well. For example, though the primary examples involve aerial vehicles and atmospheric energy, embodiments of the invention may find application in watercraft such as submersibles and the use of hydrodynamic energy such as convection currents. Thus, the present invention is not intended to be limited to the embodiments shown above but rather is to be accorded the widest scope consistent with the principles and novel features disclosed in any fashion herein.

What is claimed is:

1. A control system for an unmanned vehicle comprising:
a sensor, constructed and arranged to identify a region of convective energy located at a distance from the unmanned vehicle; and
a controller, configured to receive information from the sensor and to produce control signals to control elements of the unmanned vehicle so that the identified energy can be used by the unmanned vehicle in an operation.

2. A control system as recited in claim 1, wherein the sensor comprises one or more sensors selected from the group consisting of: a LIDAR, an infrared camera, an optical wavefront sensor, a daylight camera, a low light camera, and an image pattern recognition system.

3. A control system as recited in claim 1, wherein the convective energy identified comprises a thermal.

4. A control system as recited in claim 1, wherein the control elements comprise a motor.

5. A control system as recited in claim 1, wherein the control elements comprise control surfaces of the unmanned vehicle.

6. A control system as recited in claim 5, wherein the vehicle is an aerial vehicle and the control surfaces comprise wing surfaces.

7. A control system as recited in claim 6, wherein the wing surfaces comprise a plurality of trailing-edge flaps having associated actuators.

8. A control system as recited in claim 6, wherein the vehicle is an aerial vehicle and the control surfaces comprise tail surfaces.

9. A control system as recited in claim 6, wherein the vehicle is a watercraft and the sensor comprises one or more sensors selected from the group consisting of sonar, infrared detector, temperature sensor, and acoustic sensor.

10. A control system as recited in claim 9, wherein the vehicle is a watercraft and the control surfaces comprise hydrofoil surfaces.

11. A control system as recited in claim 1, wherein the region of convective energy comprises a thermal and the controller is configured to control the unmanned vehicle such that it travels through a central region of the thermal.

12. A control system as recited in claim 1, wherein the region of convective energy comprises a thermal and the controller is configured to control the unmanned vehicle such that it travels along a spiral path through a region of the thermal.

13. A control system as recited in claim 1, wherein the unmanned vehicle comprises an aerial vehicle having a wing and further comprising:
a lift sensor located at a surface of the wing;
a drag sensor located at a surface of the wing; and
wherein the controller is further configured to receive information from the lift and drag sensors and to use the received information to produce control signals to control adjustable aerodynamic surfaces of the wing such that a drag induced by the wing of the unmanned aerial vehicle is reduced.

14. A control system as recited in claim 13, wherein the controller is configured to produce the control signals such that induced drag is minimized.

15. A control system as recited in claim 13, wherein the controller is configured to produce the control signals such that induced drag approximates the induced drag of an elliptic wing.

16. A control system as recited in claim 13, wherein the controller is configured to produce the control signals such that the wing produces a maximum lift to drag ratio.

17. A control system as recited in claim 13, wherein the controller is configured to produce the control signals such that the wing produces an extended range and endurance.

18. A control system as recited in claim 13, wherein the controller is configured to produce the control signals such that the wing produces an increased on station persistence.

19. A control system as recited in claim 13, wherein the aerodynamic surfaces comprise a plurality of flap segments movably positioned at a trailing edge of the wing.

20. A control system as recited in claim 13, wherein the lift and drag sensors comprise electroactive pressure sensors.

21. A control system as recited in claim 20, wherein the electroactive pressure sensors are configured as weighted spatial aperture sensors.

22. A control system for an unmanned aerial vehicle having a wing, comprising:
a lift sensor located on the wing;
a drag sensor located on the wing; and
a controller configured to receive information from the lift and drag sensors and to use the received information to produce control signals to control aerodynamic surfaces of the unmanned aerial vehicle such that a drag induced by the wing of the unmanned aerial vehicle is reduced.

23. A method for controlling an unmanned aerial vehicle comprising:
measuring a lift force on a wing of the unmanned aerial vehicle;
measuring a drag force on the wing; and
using the measured lift and drag to control aerodynamic surfaces of the wing such that a drag induced by the wing is reduced.

24. A method as in claim 23, further comprising:
detecting atmospheric energy; and
controlling the vehicle such that a portion of the detected energy is used to provide lift to the vehicle.

25. A method for controlling an unmanned aerial vehicle comprising:
detecting a region of convective atmospheric energy located at a distance from the unmanned vehicle; and
autonomously controlling the vehicle such that a portion of the detected energy is used to provide lift to the vehicle.
